(19) United States
(12) Patent Application Publication
(10) Pub. No.: US 2025/0368005 A1
(43) Pub. Date: Dec. 4, 2025

(54) HEAT PUMP SYSTEM FOR A VEHICLE

(71) Applicants: HYUNDAI MOTOR COMPANY, Seoul (KR); KIA CORPORATION, Seoul (KR)

(72) Inventors: Jeawan Kim, Hwaseong-si (KR); Hochan An, Hwaseong-si (KR); Yeonho Kim, Hwaseong-si (KR); Hoyoung Jeong, Hwaseong-si (KR); Man Hee Park, Hwaseong-si (KR); Yeong Jun Kim, Hwaseong-si (KR); Jae Yeon Kim, Hwaseong-si (KR); Gwi Taek Kim, Hwaseong-si (KR)

(73) Assignees: HYUNDAI MOTOR COMPANY, Seoul (KR); KIA CORPORATION, Seoul (KR)

(21) Appl. No.: 18/920,430

(22) Filed: Oct. 18, 2024

(30) Foreign Application Priority Data
May 30, 2024 (KR) 10-2024-0070652

(51) Int. Cl. B60H 1/00

(52) U.S. Cl. CPC B60H 1/00907

(57) ABSTRACT

A heat pump system for a vehicle may include: a HVAC module, a heat-exchanger, a first expansion, a first connection line, a chiller, a second expansion valve, a gas injection device, a second connection line, and a third connection line, in order to improve cooling and heating performance by applying a gas injection device that selectively operates in an air conditioning mode of vehicle interior to increase the flow rate of the refrigerant.

### CROSS-REFERENCE TO RELATED APPLICATION

This application claims priority to and the benefit of Korean Patent Application No. 10-2024-0070652, filed in the Korean Intellectual Property Office on May 30, 2024, the entire contents of which are incorporated herein by reference.

### BACKGROUND

### (a) Field

The present disclosure relates to a heat pump system for a vehicle. More particularly, the present disclosure relates to a heat pump system capable of improving the cooling and heating performance of a vehicle.

### (b) Description of the Related Art

Generally, an air conditioning system for a vehicle includes an air conditioner unit circulating a refrigerant in order to heat or cool an interior of the vehicle.

The air conditioner unit, which is to maintain the interior of the vehicle at an appropriate temperature regardless of a change in an external temperature to maintain a comfortable interior environment, is configured to heat or cool the interior of the vehicle through heat-exchange, using a condenser and an evaporator. In this process, refrigerant discharged by a compressor is circulated back to the compressor through the condenser, a receiver drier, an expansion valve, and the evaporator.

In other words, in a cooling mode in summer, the air conditioner unit lowers a temperature and a humidity of the interior by condensing a high-temperature, high-pressure gas-phase refrigerant from the compressor by the condenser. The refrigerant then passes through the receiver drier and the expansion valve before evaporating in the evaporator.

Recently, in accordance with a continuous increase in interest in energy efficiency and an environmental pollution problem, the development of environmentally-friendly vehicles capable of substantially substituting for an internal combustion engine vehicle is required, and the environmentally-friendly vehicles are classified into electric vehicles, which are powered by either fuel cells or electricity, and hybrid vehicles, which are driven by both an engine and a battery.

In the electric vehicles or the hybrid vehicles, among these environmentally-friendly vehicles, a separate heater is not used unlike an air conditioner of a general vehicle, and an air conditioner used in the environmentally-friendly vehicles is generally called a heat pump system.

The electric vehicles powered by the fuel cells generate driving force by converting chemical reaction energy between oxygen and hydrogen into electrical energy. In this process, heat energy is generated by a chemical reaction in a fuel cell. Therefore, it is necessary in securing performance of the fuel cell to effectively remove generated heat.

In addition, the hybrid vehicles generate driving force by a motor using electricity supplied from the fuel cells described above or an electrical battery, together with an engine operated by a general fuel. Therefore, heat generated from the fuel cells or the battery and the motor should be effectively removed in order to secure performance of the motor.

Therefore, in the hybrid vehicles or the electric vehicles according to the related art, cooling means, a heat pump system, and a battery cooling system, respectively, should be configured as separate closed circuits so as to prevent heat generation of the motor, an electric component, and the battery including fuel cells.

Therefore, a size and a weight of a cooling module disposed at the front of the vehicle are increased, and a layout of connection pipes supplying a refrigerant and a coolant to each of the heat pump system, the cooling means, and the battery cooling system in an engine compartment becomes complicated.

In addition, since a battery cooling system for heating or cooling the battery according to a state of the vehicle is separately provided to obtain an optimal performance of the battery, a plurality of valves for selectively interconnecting connections pipes is employed, and thus noise and vibration due to frequent opening and closing operations of the valves may be introduced into the vehicle interior, thereby deteriorating the ride comfort.

In addition, for heating the vehicle interior, the heating performance may be deteriorated due to the lack of heat source, the electricity consumption may be increased due to the usage of the electric heater, and the power consumption of the compressor may be increased.

The above information disclosed in this Background section is provided only to enhance understanding of the background of the present disclosure, and therefore it may contain information that does not form the prior art that is already known to a person of ordinary skill in the art.

### SUMMARY

The present disclosure provides a heat pump system for a vehicle capable of improving cooling and heating performance by applying a gas injection device, which selectively operates in an air conditioning mode of vehicle interior to increase the flow rate of the refrigerant.

In one embodiment of the present disclosure, a heat pump system for a vehicle may include: a compressor configured to compress a refrigerant; a HVAC module including an internal condenser and an evaporator connected to the compressor through a refrigerant line; and an opening/closing door configured to adjust an air having passed through the evaporator to be selectively introduced into the internal condenser, based on cooling or heating of a vehicle interior. The heat pump system further includes: a heat-exchanger connected to the internal condenser through the refrigerant line, and configured to condense or evaporate the refrigerant by exchanging heat between the supplied refrigerant and the air; a first expansion valve provided on the refrigerant line between the heat-exchanger and the evaporator; an accumulator provided on the refrigerant line between the evaporator and the compressor; and a first connection line having a first end connected to the refrigerant line between the compressor and the evaporator, and a second end connected to the refrigerant line between the heat-exchanger and the evaporator. The heat pump system further includes: a chiller provided on the first connection line and configured to adjust a temperature of a selectively introduced coolant by exchanging heat between the refrigerant introduced into the first connection line and the coolant; a second expansion valve provided on the first connection line at an upstream end of the chiller; a second connection line having a first end connected to the second expansion valve, and a second end connected to the accumulator; and a gas injection device connected to the refrigerant line between the internal condenser and the heat-exchanger and configured to selectively expand the refrigerant supplied from the internal condenser or the heat-exchanger and flow the expanded refrigerant. The gas injection device is further configured to selectively supply a partial refrigerant, among the supplied refrigerant, to the compressor to increase a flow amount of the refrigerant circulating through the refrigerant line; and a third connection line having a first end connected to the refrigerant line between the heat-exchanger and the evaporator, and a second end connected to the gas injection device.

In another embodiment, the gas injection device may further include: a flash tank configured to separate a gaseous refrigerant and a liquid refrigerant from an interiorly introduced refrigerant and selectively discharge the separated refrigerants; a third expansion valve provided on the refrigerant line between the internal condenser and the heat-exchanger; a first line having a first end connected to the flash tank, and a second end connected to the third expansion valve; a second line connecting the compressor and the flash tank, and configured to selectively supply the gaseous refrigerant from the flash tank to the compressor; a third line having a first end connected to the flash tank, and a second end connected to the refrigerant line between the third expansion valve and the heat-exchanger; and, a fourth expansion valve provided on the third line.

The fourth expansion valve may be configured to: selectively expand the refrigerant supplied from the flash tank and supply the expanded refrigerant to the heat-exchanger, or supply the refrigerant supplied from the flash tank to the chiller or the first expansion valve, in an unexpanded state.

The third and the fourth expansion valve may be selectively operated in a cooling mode, a heating mode, or a heating and dehumidifying mode of the vehicle interior and configured to selectively expand the refrigerant while controlling a flowing movement of the supplied refrigerant.

The flash tank may be operated when the expanded refrigerant is supplied and configured to supply the gaseous refrigerant among the supplied refrigerant to the compressor through the second line, to increase the flow amount of the refrigerant circulating through the refrigerant line.

In another embodiment, the heat pump system for a vehicle may further include: a fifth expansion valve provided on the refrigerant line between the heat-exchanger and the first expansion valve, and connected to a first end of the second connection line; and a fourth connection line having a first end connected to the fourth expansion valve, and a second end connected to the refrigerant line between the heat-exchanger and the first expansion valve.

In one embodiment, a first end of the third connection line may be connected to the fifth expansion valve, and a second end of the third connection line may be connected to the first line.

When a waste heat of an electrical component is to be recollected in a cooling mode, a heating and dehumidifying mode, or a heating mode of the vehicle interior, the fourth connection line may be opened by the fourth expansion valve.

When the gas injection device operates in a cooling mode of the vehicle interior, a portion of the first line connecting a second end of the third connection line to the flash tank is opened, a remaining first line connecting the second end of the third connection line to the third expansion valve may be closed, the second line is opened, a portion of the third line connecting the flash tank to the fourth expansion valve may be opened by the fourth expansion valve, a remaining third line connecting the fourth expansion valve to the refrigerant line may be closed by the fourth expansion valve, the first connection line and the second connection line may be closed by the second expansion valve, the third connection line may be opened by the fifth expansion valve, the fourth connection line may be opened by the fourth expansion valve, the first expansion valve may expand the refrigerant introduced through the refrigerant line and may supply the expanded refrigerant to the evaporator, an operation of the second expansion valve may be stopped, the third expansion valve may supply the refrigerant introduced through the refrigerant line to the heat-exchanger without expansion, the fourth expansion valve may flow the refrigerant supplied from the flash tank through the third line to the fourth connection line without expansion, the fifth expansion valve may expand the refrigerant supplied from the heat-exchanger and may flow the expanded refrigerant to the third connection line, and, the flash tank may supply the gaseous refrigerant among the interiorly introduced refrigerant to the compressor through the opened second line.

When the gas injection device operates and cooling of a battery module is required in a cooling mode of the vehicle interior, a portion of the first line connecting a second end of the third connection line to the flash tank is opened, a remaining first line connecting the second end of the third connection line to the third expansion valve may be closed, the second line is opened, a portion of the third line connecting the flash tank to the fourth expansion valve may be opened by the fourth expansion valve, a remaining third line connecting the fourth expansion valve to the refrigerant line may be closed by the fourth expansion valve, a portion of the refrigerant line connecting the fifth expansion valve to a second end of the fourth connection line may be closed by the fifth expansion valve, the first connection line may be opened by an operation of the second expansion valve, the second connection line may be closed by the second expansion valve, the third connection line may be opened by the fifth expansion valve, the fourth connection line may be opened by the fourth expansion valve, the first expansion valve may expand the refrigerant introduced through the fourth connection line and a portion of the refrigerant line from the flash tank, and may supply the expanded refrigerant to the evaporator, the second expansion valve may expand the refrigerant introduced through the fourth connection line, a portion of the refrigerant line, and the first connection line from the flash tank, and may supply the expanded refrigerant to the chiller, the third expansion valve may supply the refrigerant introduced through the refrigerant line to the heat-exchanger without expansion, the fourth expansion valve may flow the refrigerant supplied from the flash tank through the third line to the fourth connection line without expansion, the fifth expansion valve may expand the refrigerant supplied from the heat-exchanger and may flow the expanded refrigerant to the third connection line, and, the flash tank may supply the gaseous refrigerant among the interiorly introduced refrigerant to the compressor through the opened second line.

When the gas injection device operates and a waste heat of an electrical component is to be recollected in a heating mode of the vehicle interior, a portion of the refrigerant line connecting the compressor and the internal condenser and a portion of the refrigerant line connecting the internal condenser and the third expansion valve may be opened by the third expansion valve, a portion of the refrigerant line connecting the first connection line and the compressor is opened, a portion of the refrigerant line connecting the heat-exchanger and the third expansion valve may be closed by the third expansion valve, a portion of the refrigerant line connecting the heat-exchanger and a second end of the fourth connection line may be closed by the fifth expansion valve, a portion of the refrigerant line connecting a second end of the first connection line to the evaporator may be closed by the first expansion valve, a portion of the refrigerant line connecting the evaporator and a first end of the first connection line may be closed, the first line may be opened by the third expansion valve, the second line is opened, a portion of the third line connecting the flash tank and the fourth expansion valve may be opened by the fourth expansion valve, a remaining third line connecting the fourth expansion valve and the refrigerant line may be closed by the fourth expansion valve, the first connection line may be opened by the second expansion valve, the second connection line may be closed by the second expansion valve, the third connection line may be closed by the fifth expansion valve, the fourth connection line may be opened by the fourth expansion valve, operations of the first expansion valve and the fifth expansion valve may be stopped, the second expansion valve may expand the refrigerant introduced through the fourth connection line and the first connection line from the flash tank and may supply the expanded refrigerant to the chiller, the third expansion valve may expand the refrigerant supplied from the internal condenser and may supply the expanded refrigerant to the flash tank, the fourth expansion valve may flow the refrigerant supplied from the flash tank through the third line to the fourth connection line without expansion, and, the flash tank may supply the gaseous refrigerant among the interiorly introduced refrigerant to the compressor through the opened second line.

When the gas injection device operates and an ambient air heat source is to be recollected in a heating mode of the vehicle interior, a portion of the refrigerant line connecting the compressor and the internal condenser and a portion of the refrigerant line connecting the internal condenser and the third expansion valve may be opened by the third expansion valve, a portion of the refrigerant line connecting the evaporator and the accumulator may be closed, a portion of the refrigerant line connecting the third expansion valve to a second end of the third line may be closed by the third expansion valve, a portion of the refrigerant line connecting the heat-exchanger to the second end of the third line may be opened by the fourth expansion valve, a portion of the refrigerant line connecting the heat-exchanger to a second end of the first connection line may be opened by the fifth expansion valve, a portion of the refrigerant line connected from a first end of the first connection line to the evaporator and, a portion of the refrigerant line connecting the evaporator to the accumulator are closed by the first expansion valve, the first line may be opened by the third expansion valve, the second line is opened, the third line may be opened by the fourth expansion valve, a portion of the first connection line connecting the second end of the first connection line to the second expansion valve may be opened by the second expansion valve, a portion of the first connection line connecting the second expansion valve to the refrigerant line by passing through the chiller may be closed by the second expansion valve, the second connection line may be opened by the second expansion valve, the third connection line may be closed by the fifth expansion valve, the fourth connection line may be closed by the fourth expansion valve, an operation of the first expansion valve may be stopped, the second expansion valve may flow the refrigerant introduced through the refrigerant line and the first connection line from the heat-exchanger to the second connection line without expansion, the third expansion valve may expand the refrigerant supplied from the internal condenser and may supply the expanded refrigerant to the flash tank, the fourth expansion valve may expand the refrigerant supplied from the flash tank through the third line, and may supply the expanded refrigerant to the heat-exchanger through the refrigerant line, the fifth expansion valve may flow the refrigerant introduced from the heat-exchanger through the refrigerant line to the refrigerant line and the first connection line without expansion, and, the flash tank may supply the gaseous refrigerant among the interiorly introduced refrigerant to the compressor through the opened second line.

When the gas injection device operates in a heating and dehumidifying mode of the vehicle interior, a portion of the refrigerant line connecting the compressor and the internal condenser and a portion of the refrigerant line connecting the internal condenser and the third expansion valve may be opened by the third expansion valve, a portion of the refrigerant line connecting the evaporator and the compressor is opened, a portion of the refrigerant line connecting a second end of the fourth connection line to the evaporator may be opened by the first expansion valve, a portion of the refrigerant line connecting the heat-exchanger and the third expansion valve may be closed by the third expansion valve, a portion of the refrigerant line connecting the heat-exchanger and the second end of the fourth connection line may be closed by the fifth expansion valve, a portion of the refrigerant line connecting the third expansion valve to a second end of the third line may be closed by the third expansion valve, the first line may be opened by the third expansion valve, the second line is opened, a portion of the third line connecting the flash tank and the fourth expansion valve may be opened by the fourth expansion valve, a remaining third line connecting the fourth expansion valve and the refrigerant line may be closed by the fourth expansion valve, the first connection line may be opened by the second expansion valve, the second connection line may be closed by the second expansion valve, the third connection line may be closed by the fifth expansion valve, the fourth connection line may be opened by the fourth expansion valve, the first expansion valve may expand the refrigerant introduced through the fourth connection line and a portion of the refrigerant line from the flash tank, and may supply the expanded refrigerant to the evaporator, the second expansion valve may expand the refrigerant introduced through the first connection line, and may supply the expanded refrigerant to the chiller, the third expansion valve may expand the refrigerant supplied from the internal condenser and may supply the expanded refrigerant to the flash tank, the fourth expansion valve may flow the refrigerant supplied from the flash tank through the third line to the fourth connection line without expansion, and the flash tank may supply the gaseous refrigerant among the interiorly introduced refrigerant to the compressor through the opened second line.

The second expansion valve, the third expansion valve, the fourth expansion valve, and the fifth expansion valve may be 3-way electronic expansion valves configured to selectively expand the refrigerant while controlling a flowing movement of the refrigerant.

In one embodiment, the heat pump system for a vehicle may further include a sub-heat-exchanger provided on the refrigerant line between the first expansion valve and the fifth expansion valve. In particular, the sub-heat-exchanger is configured to exchange heat between the refrigerant supplied from the heat-exchanger through the refrigerant line or the refrigerant supplied from the fourth connection line through the refrigerant line and the refrigerant supplied from one among the evaporator and the chiller, with each other.

In another embodiment, the heat pump system may further include: a cooling apparatus including an electrical component and a battery module through which the coolant circulates. The chiller may be connected to the electrical component through a first coolant line through which the coolant circulates, and connected to the battery module through a second coolant line through which the coolant circulates.

When a waste heat of the electrical component is to be recollected in a heating mode of the vehicle interior, the first coolant line may be opened to connect the chiller and the electrical component.

When the battery module is to be cooled in a cooling mode of the vehicle, or when a waste heat of the battery module is to be recollected in a heating mode of the vehicle interior, the second coolant line may be opened to connect the chiller and the battery module.

As described above, according to a heat pump system for a vehicle according to an embodiment, cooling and heating performance may be improved by applying a gas injection device selectively operating in an air conditioning mode of vehicle interior to increase the flow rate of the refrigerant.

In addition, according to the present disclosure, the performance of the system by using the gas injection device may be maximized while minimizing the required components, and accordingly, streamlining and simplification of the system may be achieved.

In addition, according to the present disclosure, through streamlining of an entire system, it is possible to reduce manufacturing cost and weight and improve space utilization.

### BRIEF DESCRIPTION OF THE DRAWINGS

FIG. 1 is a block diagram of a heat pump system for a vehicle according to an embodiment.

FIG. 2 is an operation diagram of a heat pump system for a vehicle according to an embodiment, for a case in which a gas injection device operates in a cooling mode of the vehicle interior.

FIG. 3 is an operation diagram of a heat pump system for a vehicle according to an embodiment, for a case in which a gas injection device operates and a battery module is to be cooled in a cooling mode of the vehicle interior.

FIG. 4 is an operation diagram of a heat pump system for a vehicle according to an embodiment, for a case in which a gas injection device operates and a waste heat of the electrical component is to be recollected in a heating mode of the vehicle interior.

FIG. 5 is an operation diagram of a heat pump system for a vehicle according to an embodiment, for a case in which a gas injection device operates and an ambient air heat source is to be recollected in a heating mode of the vehicle interior.

FIG. 6 is an operation diagram of a heat pump system for a vehicle according to an embodiment, for a case in which a gas injection device operates in a heating and dehumidifying mode of the vehicle interior.

### DETAILED DESCRIPTION

Some embodiments are hereinafter described in detail with reference to the accompanying drawings.

The embodiments disclosed in the present specification and the constructions depicted in the drawings are only the representative embodiments of the present disclosure, and do not cover the entire scope of the present disclosure. Therefore, it should be understood that there may be various equivalents and variations at the time of the application of the present disclosure.

In order to clarify the present disclosure, parts that are not related to the description are omitted, and the same elements or equivalents are referred to with the same reference numerals throughout the present disclosure.

Also, the size and thickness of each element are arbitrarily shown in the drawings, but the present disclosure is not necessarily limited thereto, and in the drawings, the thickness of layers, films, panels, regions, etc., are exaggerated for clarity.

In addition, unless explicitly described to the contrary, the word “comprise” and variations such as “comprises” or “comprising”, will be understood to imply the inclusion of stated elements but not the exclusion of any other elements.

Furthermore, each of terms, such as “ . . . unit”, “ . . . means”, “ . . . portions”, “ . . . part”, and “ . . . member” described in the specification, mean a unit of a comprehensive element that performs at least one function or operation.

When a component, device, element, or the like of the present disclosure is described as having a purpose or performing an operation, function, or the like, the component, device, or element should be considered herein as being “configured to” meet that purpose or to perform that operation or function.

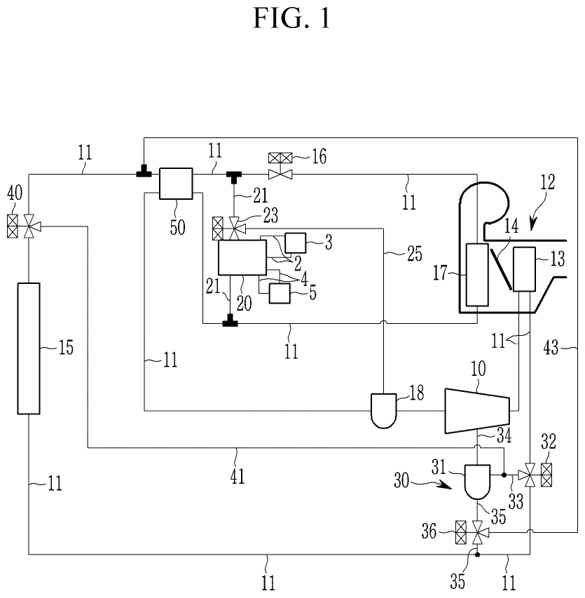

FIG. 1 is a block diagram of a heat pump system for a vehicle according to an embodiment.

A heat pump system for a vehicle according to an embodiment may improve the cooling and heating performance by applying a gas injection device 30 that selectively operates in an air conditioning mode of a vehicle interior selected among a cooling mode, a heating mode, or a heating and dehumidifying mode, and thereby by increasing a flow amount of a refrigerant.

Here, according to the heat pump system, in an electric vehicle, a cooling apparatus through which a coolant circulates and an air conditioner unit, which is an air-conditioner apparatus for cooling and heating the vehicle interior may be interconnected with each other.

In other words, referring to FIG. 1, the heat pump system may include the cooling apparatus, and the air conditioner unit including a compressor 10, a heating, ventilation, and air-conditioning (HVAC) module 12, an internal condenser 13, a heat-exchanger 15, a first expansion valve 16, an evaporator 17, a chiller 20, a first connection line 21, a second expansion valve 23, a second connection line 25, the gas injection device 30, and a third connection line 41.

In one embodiment, the cooling apparatus may include an electrical component 3 and a battery module 5 through which the coolant circulates.

The cooling apparatus may further include a radiator (not shown). The radiator may be disposed in a frontal region of the vehicle. A cooling fan (not shown) may be provided at a rear of the radiator. Accordingly, the radiator may cool the coolant through an operation of the cooling fan and heat-exchange with an ambient air.

The electrical component 3 may be connected to the chiller 20 through a first coolant line 2 through which the coolant circulates. The battery module 5 may be connected to the chiller 20 through a second coolant line 4 through which the coolant circulates.

In other words, the electrical component 3 may be connected to the first coolant line 2 and cooled in a water-cooled manner.

In addition, when a waste heat of the electrical component 3 is to be recollected in the heating mode of the vehicle interior, the first coolant line 2 may be opened to connect the chiller 20 and the electrical component 3.

Accordingly, the chiller 20 may adjust a temperature of the electrical component 3 by using the coolant heat-exchanged with the refrigerant, and may recollect the waste heat of the electrical component 3.

When the battery module 5 is to be cooled in the cooling mode of the vehicle, or when a waste heat of the battery module 5 is to be recollected in the heating mode of the vehicle interior, the second coolant line 4 may be opened to connect the chiller 20 and the battery module 5.

Here, the coolant may selectively circulate through the first coolant line 2 and the second coolant line 4 by a water pump (not shown).

In one form, the electrical component 3 may include at least one of an electric power control unit (EPCU), a motor, an inverter, an on-board charger (OBC), or an autonomous driving controller, or the like.

The electric power control apparatus, or the inverter, or the motor, or the autonomous driving controller may generate heat during driving of the vehicle, and the charger may generate heat when charging the battery module 5.

When the waste heat of the electrical component 3 is to be recollected in the heating mode of the vehicle interior, the heat generated from the electric power control apparatus, the motor, the inverter, the charger, or the autonomous driving controller may be recollected.

In one embodiment, the compressor 10 may compress the supplied refrigerant and flow the compressed refrigerant to a refrigerant line 11 such that the refrigerant may circulate along the refrigerant line 11.

The internal condenser 13 and the evaporator 17 connected to the compressor 10 through the refrigerant line 11 may be provided inside the HVAC module 12.

Here, an opening/closing door 14 configured to adjust the ambient air having passed through the evaporator 17 to be selectively introduced into the internal condenser 13 may be provided inside the HVAC module 12 between the evaporator 17 and the internal condenser 13.

At the time of heating the vehicle interior, the opening/closing door 14 may be opened such that the ambient air having passed through the evaporator 17 may be introduced into the internal condenser 13.

A high-temperature refrigerant supplied to the internal condenser 13 may increase the temperature of the ambient air passing through the internal condenser 13. In other words, the introduced ambient air is converted into a high-temperature state while passing through the internal condenser 13 and then introduced into the vehicle interior, thereby implementing heating of the vehicle interior.

To the contrary, at the time of cooling the vehicle interior, the opening/closing door 14 may close a side toward the internal condenser 13 such that the ambient air cooled while passing through the evaporator 17 may be directly introduced into the vehicle.

Accordingly, the ambient air passing through the evaporator 17 may be cooled while passing through the evaporator 17 by a low-temperature refrigerant supplied to the evaporator 17. The cooled ambient air may be introduced into the vehicle interior, thereby cooling the vehicle interior.

In one embodiment, the heat-exchanger 15 may be connected to the internal condenser 13 through the refrigerant line 11. The heat-exchanger 15 may be disposed in the frontal region of the vehicle.

Accordingly, the heat-exchanger 15 may condense or evaporate the refrigerant by heat-exchanging the introduced refrigerant with the ambient air introduced while the vehicle is running. In other words, the heat-exchanger 15 may be an air-cooled heat-exchanger configured to heat-exchange the introduced refrigerant with the ambient air.

The first expansion valve 16 may be provided on the refrigerant line 11 connecting the heat-exchanger 15 and the evaporator 17. The first expansion valve 16 may selectively expand the introduced refrigerant.

In one embodiment, the air conditioner unit may further include an accumulator 18. The accumulator 18 may be provided on the refrigerant line 11 between the evaporator 17 and the compressor 10.

The accumulator 18 may only supply the gaseous refrigerant to the compressor 10, and thereby improve the efficiency and durability of the compressor 10.

In one embodiment, the chiller 20 may exchange heat between the refrigerant supplied from the air conditioner unit and the coolant, and thereby adjust a temperature of the coolant selectively supplied through the first coolant line 2 or the second coolant line 4.

In one form, the chiller 20 may be a water-cooled heat-exchanger configured to exchange heat between the interiorly introduced refrigerant and the coolant.

Here, the chiller 20 may be connected to the refrigerant line 11 through the first connection line 21.

A first end of the first connection line 21 may be connected to the refrigerant line 11 between the heat-exchanger 15 and the first expansion valve 16. In addition, a second end of the first connection line 21 may be connected to the refrigerant line 11 between the evaporator 17 and the accumulator 18.

The chiller 20 may adjust the temperature of the coolant by exchanging heat between the coolant, selectively introduced through either the first coolant line 2 or the second coolant line 4, and the refrigerant selectively supplied from the air conditioner unit.

Accordingly, the coolant heat-exchanged with the refrigerant at the chiller 20 may be selectively supplied to the electrical component 3 and the battery module 5, to adjust the temperature of the electrical component 3 and the battery module 5.

The chiller 20 may be disposed in parallel with the heat-exchanger 15 through the first connection line 21.

In one embodiment, the second expansion valve 23 may be provided on the first connection line 21 at an upstream end of the chiller 20.

Here, when the electrical component 3 or the battery module 5 is to be cooled by using the coolant heat-exchanged with the refrigerant in the cooling mode of the vehicle interior, the second expansion valve 23 may expand the refrigerant introduced through the first connection line 21 and flow the expanded refrigerant into the chiller 20.

In other words, when the electrical component 3 or the battery module 5 is to be cooled in the cooling mode of the vehicle interior, the second expansion valve 23 may further lower the temperature of the coolant passing through an interior of the chiller 20 by expanding the refrigerant introduced into the first connection line 21 to lower its temperature, and flowing the expanded refrigerant to the chiller 20.

Accordingly, the coolant having its temperature lowered while passing through the chiller 20 may be introduced into the electrical component 3 or the battery module 5, thereby achieving more efficient cooling.

To the contrary, when the waste heat generated from the electrical component 3 or the battery module 5 is to be recollected in the heating mode of the vehicle interior, the second expansion valve 23 may expand the refrigerant introduced through the first connection line 21 and supply the expanded refrigerant to the chiller 20.

Accordingly, the chiller 20 may evaporate the refrigerant through heat-exchange with the coolant supplied through the first coolant line 2 or the second coolant line 4.

Here, the chiller 20 may recollect a waste heat of the electrical component 3 or the battery module 5 while exchanging heat between the refrigerant supplied from the second expansion valve 23 and the coolant supplied from the electrical component 3 or the battery module 5.

The second expansion valve 23 may be a 3-way electronic expansion valve having two inlets and one outlet and configured to selectively expand the refrigerant while controlling a flowing movement (e.g., a flow rate or flow direction) of the supplied refrigerant.

Here, the upstream end of the chiller 20 may be set based on a flow direction of the refrigerant. Based on the direction in which the refrigerant flows along the first connection line 21, a location where the refrigerant is introduced into the chiller 20 may be defined as the upstream end of the chiller 20, and a location where the refrigerant is discharged from the chiller 20 may be defined as a downstream end of the chiller 20.

A first end of the second connection line 25 may be connected to the second expansion valve 23. A second end of the second connection line 25 may be connected to the accumulator 18.

When the ambient air heat source is to be recollected in the heating mode of the vehicle interior, the second connection line 25, configured as such, may be opened by an operation of the second expansion valve 23.

In addition, the gas injection device 30 may be connected to the refrigerant line 11 between the internal condenser 13 and the heat-exchanger 15.

The gas injection device 30 may selectively expand the refrigerant supplied from the internal condenser 13 or the heat-exchanger 15 and flow the expanded refrigerant, and may selectively supply a partial refrigerant among the supplied refrigerant to the compressor 10, to increase the flow amount of the refrigerant circulating through the refrigerant line 11.

The gas injection device 30, configured as such, may be selectively operated in the cooling mode of the vehicle, the heating mode, or the heating and dehumidifying mode.

Here, the gas injection device 30 may include a flash tank 31, a third expansion valve 32, a first line 33, a second line 34, a third line 35, and a fourth expansion valve 36.

The flash tank 31 may separate a gaseous refrigerant and a liquid refrigerant from among the interiorly introduced refrigerant and selectively discharge the separated refrigerants.

The third expansion valve 32 may be provided on the refrigerant line 11 between the internal condenser 13 and the heat-exchanger 15.

In one embodiment, a first end of the first line 33 may be connected to the flash tank 31. A second end of the first line 33 may be connected to the third expansion valve 32.

The first line 33 may selectively supply the refrigerant supplied from the internal condenser 13 to the flash tank 31 according to an operation of the third expansion valve 32.

Here, the third expansion valve 32 may selectively expand the refrigerant introduced from the internal condenser 13. At the same time, the third expansion valve 32 may flow the expanded refrigerant or the unexpanded refrigerant to the refrigerant line 11 or the first line 33.

The second line 34 may connect the flash tank 31 and the compressor 10. When the refrigerant is supplied to the flash tank 31, the second line 34 may selectively supply the gaseous refrigerant from the flash tank 31 to the compressor 10.

In other words, the second line 34 may connect the flash tank 31 and the compressor 10 such that the gaseous refrigerant separated in the flash tank 31 may be selectively introduced to the compressor 10.

In one embodiment, a first end of the third line 35 may be connected to the flash tank 31. A second end of the third line 35 may be connected to the refrigerant line 11 between the third expansion valve 32 and the heat-exchanger 15. The fourth expansion valve 36 may be provided on the third line 35.

Here, the fourth expansion valve 36 may selectively expand the refrigerant supplied from the flash tank 31 and supply the expanded refrigerant to the heat-exchanger 15.

On the other hand, the fourth expansion valve 36 may supply the refrigerant supplied from the flash tank 31 to the chiller 20 or the first expansion valve 16, in an unexpanded state.

Here, the fourth expansion valve 36 may selectively expand the refrigerant supplied from the flash tank 31 through the third line 35 and supply the expanded refrigerant to the heat-exchanger 15.

On the other hand, the fourth expansion valve 36 may supply the refrigerant supplied from the flash tank 31 through the third line 35 to the chiller 20 or the evaporator 17, in an unexpanded state.

Here, the third expansion valve 32 and the fourth expansion valve 36 may be selectively operated in the air conditioning mode of the vehicle interior, including the cooling mode, the heating mode, or the heating and dehumidifying mode of the vehicle interior, and may selectively expand the refrigerant while controlling the flowing movement of the refrigerant supplied into the gas injection device 30.

In one embodiment, the third expansion valve 32 and the fourth expansion valve 36 may be a 3-way electronic expansion valve having one inlet and two outlets and configured to selectively expand the refrigerant while controlling the flowing movement of the refrigerant.

In the gas injection device 30 configured as such, the flash tank 31 may be operated when the expanded refrigerant is supplied in the air conditioning mode of the vehicle interior.

The flash tank 31 may supply the gaseous refrigerant among the supplied refrigerant to the compressor 10 through the second line 34, and thereby increase the flow amount of the refrigerant circulating through the refrigerant line 11.

In one embodiment, the third connection line 41 may have a first end connected to the refrigerant line 11 between the heat-exchanger 15 and the evaporator 17. In more detail, the first end of the third connection line 41 may be connected to the refrigerant line 11 between the heat-exchanger 15 and the first expansion valve 16.

A second end of the third connection line 41 may be connected to the gas injection device 30.

The third connection line 41, configured as such, may be opened in the cooling mode of the vehicle interior, and may be closed in the heating mode and the heating and dehumidifying mode.

In another embodiment, the heat pump system may further include a fifth expansion valve 40 and a fourth connection line 43.

In one embodiment, the fifth expansion valve 40 may be provided on the refrigerant line 11 between the heat-exchanger 15 and the first expansion valve 16. The first end of the third connection line 41 may be connected to the fifth expansion valve 40.

In other words, the first end of the third connection line 41 may be connected to the refrigerant line 11 through the fifth expansion valve 40. The second end of the third connection line 41 may be connected to the first line 33.

Here, the fifth expansion valve 40 may be a 3-way electronic expansion valve having one inlet and two outlets and configured to selectively expand the refrigerant while controlling the flowing movement of the refrigerant.

In addition, a first end of the fourth connection line 43 may be connected to the fourth expansion valve 36. A second end of the fourth connection line 43 may be connected to the refrigerant line 11 between the heat-exchanger 15 and the first expansion valve 16.

In more detail, the second end of the fourth connection line 43 may be connected to the refrigerant line 11 between the fifth expansion valve 40 and the first expansion valve 16, based on the flow direction of the refrigerant.

Here, when the waste heat of the electrical component 3 is to be recollected in the cooling mode, the heating and dehumidifying mode, or the heating mode of the vehicle interior, the fourth connection line 43 may be opened by the fourth expansion valve 36.

In another embodiment, the heat pump system may further include a sub-heat-exchanger 50.

The sub-heat-exchanger 50 may be provided on the refrigerant line 11 between the first expansion valve 16 and the fifth expansion valve 40. More specifically, the sub-heat-exchanger 50 may be provided on the refrigerant line 11 between the second end of the fourth connection line 43 the first expansion valve 16.

The sub-heat-exchanger 50 may exchange heat between the refrigerant supplied from the heat-exchanger 15 through the refrigerant line 11 or the refrigerant supplied from the fourth connection line 43 through the refrigerant line 11 and the refrigerant supplied from one among the evaporator 17 and the chiller 20.

Here, the sub-heat-exchanger 50 may be a double-tube heat-exchanger that exchanges heat between refrigerants having different temperatures.

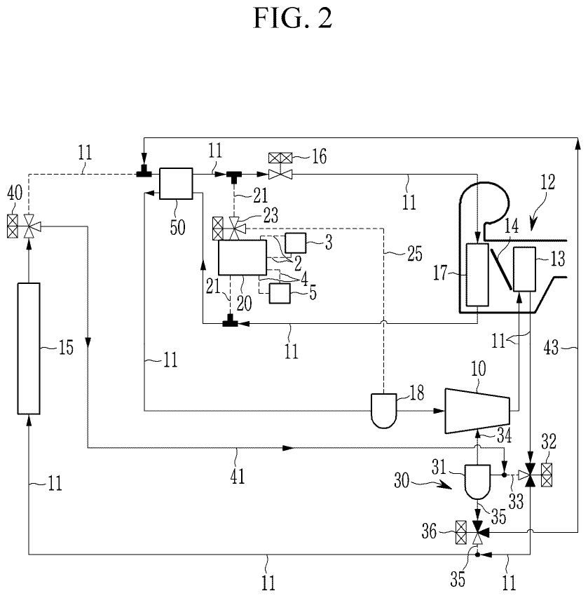

An operation and action of a heat pump system according to an embodiment is described in detail with reference to FIG. 2 to FIG. 6.

First, an operation of a heat pump system for a vehicle according to an embodiment for the case in which the gas injection device 30 operates in the cooling mode of the vehicle interior is described in detail with reference to FIG. 2.

FIG. 2 is an operation diagram of a heat pump system for a vehicle according to an embodiment, for the case in which the gas injection device operates in the cooling mode of the vehicle interior.

Referring to FIG. 2, a portion of the first line 33 connecting the second end of the third connection line 41 to the flash tank 31 may be opened.

Simultaneously, a remaining first line 33 connecting the second end of the third connection line 41 to the third expansion valve 32 may be closed. In addition, the second line 34 may be opened.

Here, the third expansion valve 32 may supply the refrigerant introduced from the internal condenser 13 to the heat-exchanger 15 without expansion. In this case, the heat-exchanger 15 may condense the refrigerant supplied from the third expansion valve 32 through heat-exchange with the ambient air.

Meanwhile, a portion of the third line 35 connecting the flash tank 31 to the fourth expansion valve 36 may be opened by the fourth expansion valve 36.

Simultaneously, a remaining third line 35 connecting the fourth expansion valve 36 to the refrigerant line 11 may be closed by the fourth expansion valve 36.

In the present embodiment, the first connection line 21 and the second connection line 25 may be closed by the second expansion valve 23. In other words, the operation of the second expansion valve 23 may be stopped.

The third connection line 41 may be opened by the fifth expansion valve 40. The fourth connection line 43 may be opened by the fourth expansion valve 36.

In addition, the refrigerant line 11 connecting the fifth expansion valve 40 to the second end of the fourth connection line 43 may be closed by the fifth expansion valve 40.

Here, the fourth expansion valve 36 may flow the refrigerant supplied from the flash tank 31 through the third line 35 to the fourth connection line 43 without expansion.

In addition, the fifth expansion valve 40 may expand the refrigerant supplied from the heat-exchanger 15 and flow the expanded refrigerant to the third connection line 41.

Then, the refrigerant flowing along the third connection line 41 may be supplied to the flash tank 31 through the first line 33. Accordingly, the expanded refrigerant may be introduced into the flash tank 31.

The flash tank 31 may supply the gaseous refrigerant among the interiorly introduced refrigerant to the compressor 10 through the opened second line 34.

In other words, the gas injection device 30 may flow the gaseous refrigerant separated while passing through the flash tank 31 back to the compressor 10 through the second line 34, thereby increasing the flow amount of the refrigerant circulating through the refrigerant line 11.

Meanwhile, the liquid refrigerant stored in the flash tank 31 may flow sequentially along the third line 35 and the fourth connection line 43 opened through an operation of the fourth expansion valve 36.

The refrigerant flowing through the fourth connection line 43 may pass through the sub-heat-exchanger 50 along the refrigerant line 11, and then introduced into the first expansion valve 16.

The first expansion valve 16 may expand the refrigerant introduced through the refrigerant line 11 and supply the expanded refrigerant to the evaporator 17.

Here, the ambient air introduced into the HVAC module 12 may be cooled while passing through the evaporator 17 by the low-temperature refrigerant introduced into the evaporator 17.

At this time, the opening/closing door 14 may close a portion to pass through the internal condenser 13 such that the cooled ambient air may not pass through the internal condenser 13. Therefore, the cooled ambient air may cool the vehicle interior by being directly introduced into the vehicle interior.

Meanwhile, the refrigerant having passed through the evaporator 17 may pass through the sub-heat-exchanger 50 along the refrigerant line 11.

Here, the sub-heat-exchanger 50 may additionally condense the refrigerant supplied from the flash tank 31 through the fourth connection line 43 and the refrigerant line 11, through heat-exchange with the refrigerant supplied from the evaporator 17.

The refrigerant from the evaporator 17 having passed through the sub-heat-exchanger 50 may be introduced into the accumulator 18 along the refrigerant line 11. Thereafter, the refrigerant may pass through the accumulator 18 and be introduced into the compressor 10.

In other words, the refrigerant having passed through the accumulator 18 and the refrigerant supplied from the flash tank 31 through the second line 34 may be introduced into the compressor 10. The introduced refrigerant may be compressed by the compressor 10.

The refrigerant compressed at the compressor 10 may pass through the internal condenser 13, and then may be supplied to the third expansion valve 32 along the refrigerant line 11.

Then, the heat pump system may repeatedly perform the above-described processes.

In other words, the heat pump system may increase the flow amount of the refrigerant flowing along the refrigerant line 11, while repeatedly performing the above-described operation.

In addition, the heat pump system may improve an overall cooling performance and efficiency and efficiently cool the vehicle interior by increasing the flow amount of the refrigerant flowing along the refrigerant line 11.

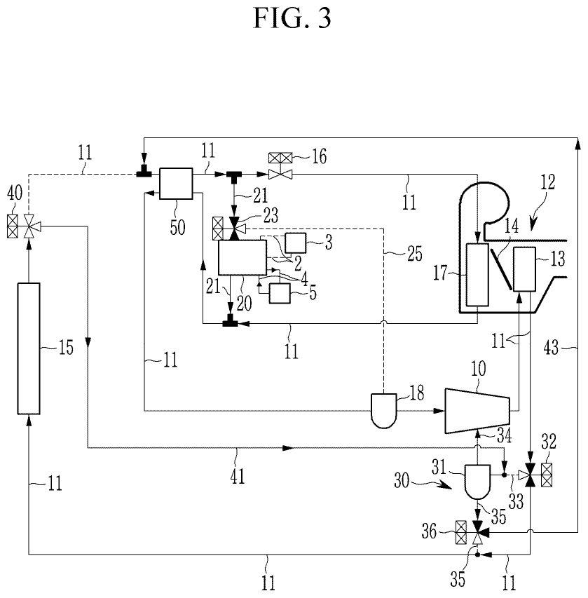

An operation of a heat pump system for a vehicle according to an embodiment when the gas injection device 30 operates and cooling of the battery module 5 is required in the cooling mode of the vehicle interior is described in detail with reference to FIG. 3.

FIG. 3 is an operation diagram of a heat pump system for a vehicle according to an embodiment, for the case in which the gas injection device operates and the battery module is to be cooled in the cooling mode of the vehicle interior.

Referring to FIG. 3, a portion of the first line 33 connecting the second end of the third connection line 41 to the flash tank 31 may be opened.

Simultaneously, a remaining first line 33 connecting the second end of the third connection line 41 to the third expansion valve 32 may be closed. In addition, the second line 34 may be opened.

Here, the third expansion valve 32 may supply the refrigerant introduced through the refrigerant line 11 from the internal condenser 13 to the heat-exchanger 15 without expansion. In this case, the heat-exchanger 15 may condense the refrigerant supplied from the third expansion valve 32 through heat-exchange with the ambient air.

Meanwhile, a portion of the third line 35 connecting the flash tank 31 to the fourth expansion valve 36 may be opened by the fourth expansion valve 36.

Simultaneously, a remaining third line 35 connecting the fourth expansion valve 36 to the refrigerant line 11 may be closed by the fourth expansion valve 36.

In the present embodiment, the first connection line 21 may be opened by the second expansion valve 23. The second connection line 25 may be closed by the second expansion valve 23. The third connection line 41 may be opened by the fifth expansion valve 40.

In addition, the fourth connection line 43 may be opened by the fourth expansion valve 36.

In addition, the refrigerant line 11 connecting the fifth expansion valve 40 to the second end of the fourth connection line 43 may be closed by the fifth expansion valve 40.

Here, the fourth expansion valve 36 may flow the refrigerant supplied from the flash tank 31 through the third line 35 to the fourth connection line 43 without expansion.

In addition, the fifth expansion valve 40 may expand the refrigerant supplied from the heat-exchanger 15 and flow the expanded refrigerant to the third connection line 41.

Then, the refrigerant flowing along the third connection line 41 may be supplied to the flash tank 31 through the first line 33. Accordingly, the expanded refrigerant may be introduced into the flash tank 31.

The flash tank 31 may supply the gaseous refrigerant among the interiorly introduced refrigerant to the compressor 10 through the opened second line 34.

In other words, the gas injection device 30 may flow the gaseous refrigerant separated while passing through the flash tank 31 back to the compressor 10 through the second line 34, thereby increasing the flow amount of the refrigerant circulating through the refrigerant line 11.

Meanwhile, the liquid refrigerant stored in the flash tank 31 may flow sequentially along the third line 35 and the fourth connection line 43 opened through the operation of the fourth expansion valve 36.

The refrigerant flowing through the fourth connection line 43 may pass through the sub-heat-exchanger 50 along the refrigerant line 11. A partial refrigerant among the refrigerant having passed through the sub-heat-exchanger 50 may be introduced into the second expansion valve 23 along the first connection line 21.

Here, the second expansion valve 23 may expand the refrigerant introduced through the fourth connection line 43, a portion of the refrigerant line 11, and the first connection line 21 from the flash tank 31.

Then, the second expansion valve 23 may supply the expanded refrigerant to the chiller 20 through the first connection line 21.

The refrigerant introduced into the chiller 20 may exchange heat with the coolant supplied from the battery module 5 through the second coolant line 4, and thereby may cool the coolant.

The coolant cooled at the chiller 20 may be supplied to the battery module 5 along the second coolant line 4. Accordingly, the battery module 5 may be efficiently cooled by the coolant cooled at the chiller 20.

In other words, the coolant circulated through the second coolant line 4 may efficiently cool the battery module 5 while repeatedly performing the above-described operations.

Meanwhile, a remaining refrigerant among the refrigerant having passed through the sub-heat-exchanger 50 may be introduced into the first expansion valve 16 along the refrigerant line 11.

The first expansion valve 16 may expand the refrigerant introduced through the refrigerant line 11 and supply the expanded refrigerant to the evaporator 17.

Here, the ambient air introduced into the HVAC module 12 may be cooled while passing through the evaporator 17 by the low-temperature refrigerant introduced into the evaporator 17.

At this time, the opening/closing door 14 may close a portion to pass through the internal condenser 13 such that the cooled ambient air may not pass through the internal condenser 13. Therefore, the cooled ambient air may cool the vehicle interior by being directly introduced into the vehicle interior.

Meanwhile, the refrigerant having passed through the evaporator 17 and the chiller 20, respectively may pass through the sub-heat-exchanger 50 along the refrigerant line 11.

Here, the sub-heat-exchanger 50 may additionally condense the refrigerant supplied from the flash tank 31 through the fourth connection line 43 and the refrigerant line 11, through heat-exchange with the refrigerant supplied from the evaporator 17 and the chiller 20 respectively.

The refrigerant from the evaporator 17 and the chiller 20 having passed through the sub-heat-exchanger 50 may be introduced into the accumulator 18 along the refrigerant line 11. Thereafter, the refrigerant may pass through the accumulator 18 and be introduced into the compressor 10.

In other words, the refrigerant having passed through the accumulator 18 and the refrigerant supplied from the flash tank 31 through the second line 34 may be introduced into the compressor 10. The introduced refrigerant may be compressed by the compressor 10.

The refrigerant compressed at the compressor 10 may pass through the internal condenser 13, and then may be supplied to the third expansion valve 32 along the refrigerant line 11.

Then, the heat pump system may repeatedly perform the above-described processes.

In other words, the heat pump system may increase the flow amount of the refrigerant flowing along the refrigerant line 11, while repeatedly performing the above-described operation.

In addition, the heat pump system may improve an overall cooling performance and efficiency and efficiently cool the vehicle interior by increasing the flow amount of the refrigerant flowing along the refrigerant line 11.

Simultaneously, the heat pump system may efficiently cool the battery module 5 by using the low-temperature coolant cooled at the chiller 20.

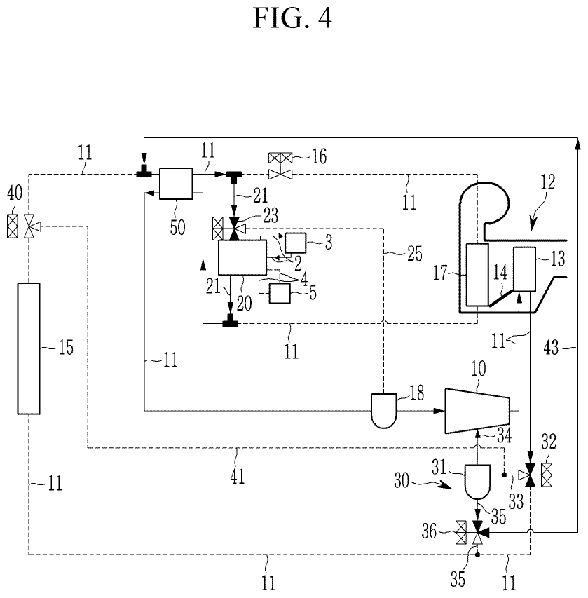

An operation of a heat pump system for a vehicle according to an embodiment for the case in which the gas injection device 30 operates and the waste heat of the electrical component 3 is to be recollected in the heating mode of the vehicle interior is described in detail with reference to FIG. 4.

FIG. 4 is an operation diagram of a heat pump system for a vehicle according to an embodiment, for the case in which the gas injection device operates and the waste heat of the electrical component is to be recollected in the heating mode of the vehicle interior.

Referring to FIG. 4, the heat pump system may recollect the waste heat of the electrical component 3 while the gas injection device 30 is being operated.

When the gas injection device 30 is operated in in the heating mode of the vehicle interior, an operation of the first expansion valve 16 may be stopped. Accordingly, a supply of the refrigerant to the evaporator 17 may be stopped.

In such a state, a portion of the refrigerant line 11 connecting the compressor 10 and the internal condenser 13 and a portion of the refrigerant line 11 connecting the internal condenser 13 and the third expansion valve 32 may be opened by the third expansion valve 32.

Simultaneously, a portion of the refrigerant line 11 connecting the first connection line 21 and the compressor 10 may be opened.

In addition, a portion of the refrigerant line 11 connecting the heat-exchanger 15 and the third expansion valve 32 may be closed by the third expansion valve 32.

A portion of the refrigerant line 11 connecting the heat-exchanger 15 and the second end of the fourth connection line 43 may be closed by the fifth expansion valve 40.

A portion of the refrigerant line 11 connecting the second end of the first connection line 21 to the evaporator 17 may be closed by the first expansion valve 16.

In addition, a portion of the refrigerant line 11 connecting the evaporator 17 and the first end of the first connection line 21 may be closed.

In the present embodiment, the first line 33 may be opened by the third expansion valve 32. In addition, the second line 34 may be opened.

In addition, a portion of the third line 35 connecting the flash tank 31 and the fourth expansion valve 36 may be opened by the fourth expansion valve 36. At the same time, a remaining third line 35 connecting the fourth expansion valve 36 and the refrigerant line 11 may be closed by the fourth expansion valve 36.

Here, the third expansion valve 32 may expand the refrigerant supplied from the internal condenser 13. Thereafter, the third expansion valve 32 may supply the expanded refrigerant to the flash tank 31 through the first line 33.

Accordingly, the flash tank 31 may supply the gaseous refrigerant among the interiorly introduced refrigerant to the compressor 10 through the opened second line 34.

In other words, the gas injection device 30 may flow the gaseous refrigerant separated while passing through the flash tank 31 back to the compressor 10 through the second line 34, thereby increasing the flow amount of the refrigerant circulating through the refrigerant line 11.

Meanwhile, the first connection line 21 may be opened by the second expansion valve 23. At the same time, the second connection line 25 may be closed by the second expansion valve 23.

The third connection line 41 may be closed by the fifth expansion valve 40. Here, an operation of the fifth expansion valve 40 may be stopped.

In addition, the fourth connection line 43 may be opened by the fourth expansion valve 36.

Accordingly, the liquid refrigerant stored in the flash tank 31 may flow to the fourth expansion valve 36 through the opened third line 35. Here, the fourth expansion valve 36 may flow the refrigerant supplied from the flash tank 31 through the third line 35 to the fourth connection line 43 without expansion.

In addition, the second expansion valve 23 may expand the refrigerant introduced through the fourth connection line 43 and the first connection line 21 from the flash tank 31. The expanded refrigerant may be supplied to the chiller 20 through the first connection line 21.

The refrigerant introduced into the chiller 20 may exchange heat with the coolant supplied from the electrical component 3 through the first coolant line 2, thereby cooling the coolant, and at the same time, evaporating the refrigerant.

At this time, the coolant may have its temperature increased by recollecting the waste heat from the electrical component 3 while cooling the electrical component 3. The coolant having its temperature increased by such an operation may be supplied to the chiller 20.

In other words, the chiller 20 may recollect the waste heat of the electrical component 3 while exchanging heat between the coolant supplied from the electrical component 3 through the first coolant line 2 and the refrigerant.

The refrigerant having absorbed the waste heat of the electrical component 3 at the chiller 20 may pass through the sub-heat-exchanger 50 along the refrigerant line 11 connected to the first connection line 21.

Here, the sub-heat exchanger 50 may additionally evaporate the refrigerant supplied from the flash tank 31 through the fourth connection line 43 and the refrigerant line 11 by heat-exchanging with the refrigerant supplied from the chiller 20.

The refrigerant having passed through the sub-heat-exchanger 50 may pass through the accumulator 18 along the refrigerant line 11, and then may be supplied to the compressor 10.

In other words, the refrigerant having passed through the accumulator 18 and the refrigerant supplied from the flash tank 31 through the second line 34 may be introduced into the compressor 10. The introduced refrigerant may be compressed by the compressor 10.

The refrigerant compressed at the compressor 10 may be supplied to the internal condenser 13 along the refrigerant line 11. Here, the refrigerant supplied to the internal condenser 13 may increase the temperature of the ambient air introduced into the HVAC module 12.

The opening/closing door 14 may be opened such that the ambient air introduced into the HVAC module 12 and having passed through the evaporator 17 may pass through the internal condenser 13.

Accordingly, when passing through the evaporator 17 that is not supplied with the refrigerant, the ambient air introduced from the outside may be introduced at a room-temperature state without being cooled. The introduced ambient air may be converted into the high-temperature state while passing through the internal condenser 13 and then introduced into the vehicle interior, thereby implementing heating of the vehicle interior.

In addition, the refrigerant condensed at the internal condenser 13 may be supplied to the flash tank 31 along the first line 33, in the state expanded the third expansion valve 32.

As such, a heat pump system according to an embodiment may smoothly recollect the waste heat from the coolant whose temperature is increased while passing through the electrical component 3 by the chiller 20 while the vehicle is running, together with an operation of the gas injection device 30, thereby improving the overall heating performance and efficiency.

In addition, the present disclosure may improve the heating efficiency and performance while minimizing the usage of a separate electric heater.

In addition, the gas injection device 30 may increase the flow amount of the refrigerant circulating through the refrigerant line 11, thereby maximizing the heating performance.

The present embodiment takes an example of recollecting the waste heat of the electrical component 3, but is not limited thereto, and at least one among the waste heat of the electrical component 3 or the waste heat of the battery module 5 may be selectively recollected.

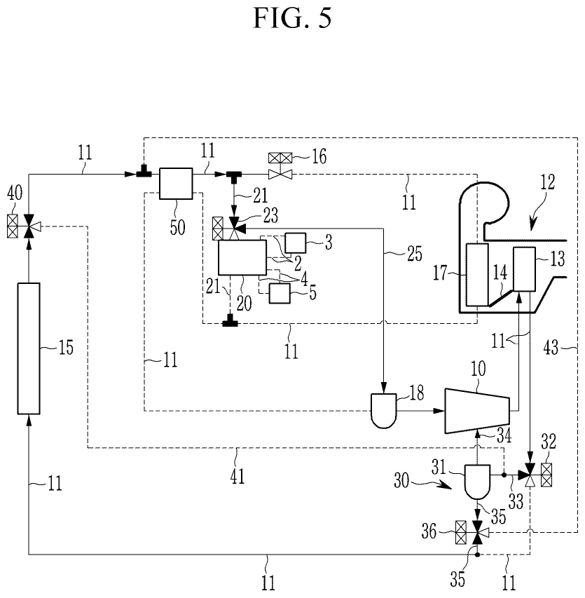

An operation of a heat pump system for a vehicle according to an embodiment for the case in which the gas injection device 30 operates and the ambient air heat source is to be recollected in the heating mode of the vehicle interior is described in detail with reference to FIG. 5.

FIG. 5 is an operation diagram of a heat pump system for a vehicle according to an embodiment, for the case in which the gas injection device operates and the ambient air heat source is to be recollected in the heating mode of the vehicle interior.

Referring to FIG. 5, the heat pump system may absorb the ambient air heat source from the ambient air, in the state that the gas injection device 30 is being operated.

In other words, when the gas injection device 30 is operated in in the heating mode of the vehicle interior, an operation of the first expansion valve 16 may be stopped. Accordingly, the supply of the refrigerant to the evaporator 17 may be stopped.

In such a state, a portion of the refrigerant line 11 connecting the compressor 10 and the internal condenser 13 and a portion of the refrigerant line 11 connecting the internal condenser 13 and the third expansion valve 32 may be opened by the third expansion valve 32.

In addition, a portion of the refrigerant line 11 connecting the third expansion valve 32 to the second end of the third line 35 may be closed by the third expansion valve 32.

Simultaneously, a portion of the refrigerant line 11 connecting the evaporator 17 and the accumulator 18 may be closed. A portion of the refrigerant line 11 connecting the heat exchanger 15 to the second end of the third line 35 may be opened by the fourth expansion valve 36.

In addition, a portion of the refrigerant line 11 connecting the heat-exchanger 15 to the second end of the first connection line 21 may be opened by the fifth expansion valve 40.

In addition, a portion of the refrigerant line 11 connecting the first end of the first connection line 21 to the evaporator 17 and a portion of the refrigerant line 11 connecting the evaporator 17 to the accumulator 18 may be closed by the first expansion valve 16.

In one embodiment, the first line 33 may be opened by the operation of the third expansion valve 32. In addition, the second line 34 may be opened.

Here, the third expansion valve 32 may expand the refrigerant supplied from the internal condenser 13. Thereafter, the third expansion valve 32 may supply the expanded refrigerant to the flash tank 31 through the first line 33.

Accordingly, the flash tank 31 may supply the gaseous refrigerant among the interiorly introduced refrigerant to the compressor 10 through the opened second line 34.

In other words, the gas injection device 30 may flow the gaseous refrigerant separated while passing through the flash tank 31 back to the compressor 10 through the second line 34, thereby increasing the flow amount of the refrigerant circulating through the refrigerant line 11.

Meanwhile, the third line 35 may be opened by the fourth expansion valve 36.

Here, the fourth expansion valve 36 may expand the refrigerant supplied from the flash tank 31 through the third line 35. The refrigerant expanded by the fourth expansion valve 36 may be supplied to the heat-exchanger 15 along the refrigerant line 11.

In other words, the liquid refrigerant stored in the flash tank 31 may be expanded through the operation of the fourth expansion valve 36, and may flow to the heat-exchanger 15 along the refrigerant line 11 connected to the third line 35.

Here, the heat-exchanger 15 may evaporate the refrigerant while exchanging heat between the refrigerant supplied from the fourth expansion valve 36 and the ambient air. At this time, the refrigerant may directly absorb the ambient air heat source from the ambient air.

In the present embodiment, a portion of the first connection line 21 connecting the second end of the first connection line 21 to the second expansion valve 23 may be opened by the second expansion valve 23.

Simultaneously, a portion of the first connection line 21 connecting the second expansion valve 23 to the refrigerant line 11 by passing through the chiller 20 may be closed by the second expansion valve 23.

In addition, the second connection line 25 may be opened by the second expansion valve 23. The third connection line 41 may be closed by the fifth expansion valve 40. In addition, the fourth connection line 43 may be closed by the fourth expansion valve 36.

In such a state, the fifth expansion valve 40 may flow the refrigerant introduced through the refrigerant line 11 from the heat-exchanger 15 to the refrigerant line 11 and the first connection line 21 without expansion.

In addition, the second expansion valve 23 may flow the refrigerant introduced through the refrigerant line 11 and the first connection line 21 from the heat-exchanger 15 to the second connection line 25 without expansion.

The refrigerant flowing through the second connection line 25 may pass through the accumulator 18, and then may be supplied to the compressor 10.

In other words, the refrigerant having recollected the ambient air heat source while passing through the heat-exchanger 15 may flow along the refrigerant line 11 and the second connection line 25 and pass through the accumulator 18. Thereafter, the refrigerant may be supplied to the compressor 10.

Accordingly, the refrigerant having passed through the accumulator 18 and the refrigerant supplied from the flash tank 31 through the second line 34 may be introduced into the compressor 10. The introduced refrigerant may be compressed by the compressor 10.

The refrigerant compressed at the compressor 10 may be supplied to the internal condenser 13 along the refrigerant line 11. Here, the refrigerant supplied to the internal condenser 13 may increase the temperature of the ambient air introduced into the HVAC module 12.

The opening/closing door 14 may be opened such that the ambient air introduced into the HVAC module 12 and having passed through the evaporator 17 may pass through the internal condenser 13.

Accordingly, when passing through the evaporator 17 that is not supplied with the refrigerant, the ambient air introduced from the outside may be introduced at a room-temperature state without being cooled. The introduced ambient air may be converted into the high-temperature state while passing through the internal condenser 13 and then introduced into the vehicle interior, thereby implementing heating of the vehicle interior.

In addition, the refrigerant condensed at the internal condenser 13 may be supplied to the flash tank 31 along the first line 33, in the state expanded the third expansion valve 32.

As such, a heat pump system according to an embodiment may recollect the ambient air heat source by the heat-exchanger 15 while the vehicle is running, together with the operation of the gas injection device 30, thereby improving the overall heating performance and efficiency.

In addition, the present disclosure may improve the heating efficiency and performance while minimizing the usage of a separate electric heater. In addition, the gas injection device 30 may increase the flow amount of the refrigerant circulating through the refrigerant line 11, thereby maximizing the heating performance.

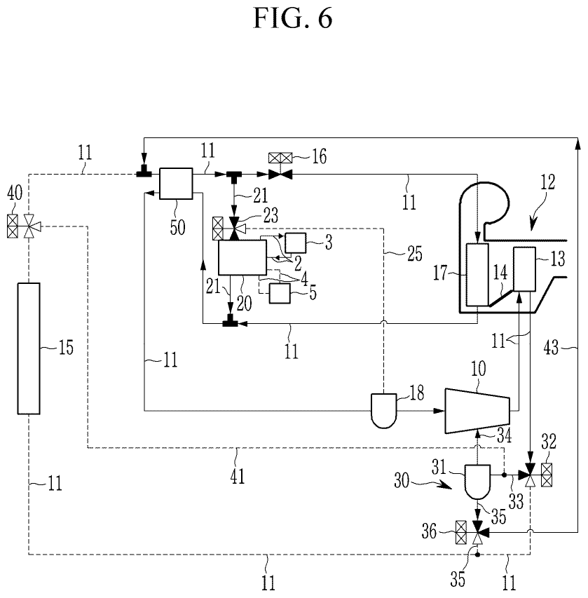

In addition, an operation of a heat pump system for a vehicle according to an embodiment for the case in which the gas injection device 30 is operated in the heating and dehumidifying mode of the vehicle interior will be described in detail with reference to FIG. 6.

FIG. 6 is an operation diagram of a heat pump system for a vehicle according to an embodiment, for the case in which the gas injection device is operated in the heating and dehumidifying mode of the vehicle interior.

Referring to FIG. 6, a portion of the refrigerant line 11 connecting the compressor 10 and the internal condenser 13 and a portion of the refrigerant line 11 connecting the internal condenser 13 and the third expansion valve 32 may be opened by the operation of the third expansion valve 32.

Simultaneously, a portion of the refrigerant line 11 connecting the evaporator 17 and the compressor 10 may be opened. In addition, a portion of the refrigerant line 11 connecting the second end of the fourth connection line 43 to the evaporator 17 may be opened by the first expansion valve 16.

In one embodiment, a portion of the refrigerant line 11 connecting the heat-exchanger 15 and the third expansion valve 32 may be closed by the third expansion valve 32.

A portion of the refrigerant line 11 connecting the heat-exchanger 15 and the second end of the fourth connection line 43 may be closed by the fifth expansion valve 40.

In addition, a portion of the refrigerant line 11 connecting the third expansion valve 32 to the second end of the third line 35 may be closed by the third expansion valve 32.

In another embodiment, the first line 33 may be opened by the third expansion valve 32. In addition, the second line 34 may be opened.

In addition, a portion of the third line 35 connecting the flash tank 31 and the fourth expansion valve 36 may be opened by the fourth expansion valve 36. At the same time, a remaining third line 35 connecting the fourth expansion valve 36 and the refrigerant line 11 may be closed by the fourth expansion valve 36.

Here, the third expansion valve 32 may expand the refrigerant supplied from the internal condenser 13. Thereafter, the third expansion valve 32 may supply the expanded refrigerant to the flash tank 31 through the first line 33.

Accordingly, the flash tank 31 may supply the gaseous refrigerant among the interiorly introduced refrigerant to the compressor 10 through the opened second line 34.

In other words, the gas injection device 30 may flow the gaseous refrigerant separated while passing through the flash tank 31 back to the compressor 10 through the second line 34, thereby increasing the flow amount of the refrigerant circulating through the refrigerant line 11.

Meanwhile, the first connection line 21 may be opened by the second expansion valve 23. At the same time, the second connection line 25 may be closed by the second expansion valve 23.

The third connection line 41 may be closed by the fifth expansion valve 40. Here, an operation of the fifth expansion valve 40 may be stopped.

In addition, the fourth connection line 43 may be opened by the fourth expansion valve 36.

Accordingly, the liquid refrigerant stored in the flash tank 31 may flow to the fourth expansion valve 36 through the opened third line 35. Here, the fourth expansion valve 36 may flow the refrigerant supplied from the flash tank 31 through the third line 35 to the fourth connection line 43 without expansion.

The refrigerant flowing through the fourth connection line 43 may pass through the sub-heat-exchanger 50 along the refrigerant line 11. A partial refrigerant among the refrigerant having passed through the sub-heat-exchanger 50 may be introduced into the second expansion valve 23 along the first connection line 21.

Here, the second expansion valve 23 may expand the refrigerant introduced through the fourth connection line 43, a portion of the refrigerant line 11, and the first connection line 21 from the flash tank 31.

Then, the second expansion valve 23 may supply the expanded refrigerant to the chiller 20 through the first connection line 21.

The refrigerant supplied to the chiller 20 may exchange heat with the coolant supplied from the electrical component 3 through the first coolant line 2, and thereby may cool the coolant.

At this time, the coolant may have its temperature increased by recollecting the waste heat from the electrical component 3 while cooling the electrical component 3. The coolant having its temperature increased by such an operation may be supplied to the chiller 20.

Here, the chiller 20 may recollect the waste heat of the electrical component 3 while exchanging heat between the coolant supplied from the electrical component 3 through the first coolant line 2 and the refrigerant.

Meanwhile, a remaining refrigerant among the refrigerant having passed through the sub-heat exchanger 50 may be introduced into the first expansion valve 16 along the refrigerant line 11. The first expansion valve 16 may expand the refrigerant introduced through the refrigerant line 11 and supply the expanded refrigerant to the evaporator 17.

In other words, the first expansion valve 16 may expand the refrigerant introduced through the fourth connection line 43 and a portion of the refrigerant line 11 through the flash tank 31, and supply the expanded refrigerant to the evaporator 17.

The refrigerant having passed through the evaporator 17 and the chiller 20, respectively may pass through the sub-heat-exchanger 50 along the refrigerant line 11.

Here, the sub-heat-exchanger 50 may additionally condense the refrigerant supplied from the flash tank 31 through the fourth connection line 43 and the refrigerant line 11, through exchanging heat between the refrigerant supplied from the evaporator 17 and the chiller 20 respectively.

The refrigerant from the evaporator 17 and the chiller 20 having passed through the sub-heat exchanger 50 may be introduced into the accumulator 18 along the refrigerant line 11. Thereafter, the refrigerant may pass through the accumulator 18 and be supplied to the compressor 10.

In other words, the refrigerant having passed through the accumulator 18 and the refrigerant supplied from the flash tank 31 through the second line 34 may be introduced into the compressor 10. The introduced refrigerant may be compressed by the compressor 10.

The refrigerant compressed at the compressor 10 may be supplied to the internal condenser 13 along the refrigerant line 11. Here, the refrigerant supplied to the internal condenser 13 may increase the temperature of the ambient air introduced into the HVAC module 12.

The opening/closing door 14 may be opened such that the ambient air introduced into the HVAC module 12 and having passed through the evaporator 17 may pass through the internal condenser 13.

Here, the air introduced into the HVAC module 12 may be dehumidified while passing through the evaporator 17 by the low-temperature refrigerant introduced into the evaporator 17. Thereafter, by being converted into the high-temperature state while passing through the internal condenser 13 and then being introduced into the vehicle interior, it may smoothly heat and dehumidify the vehicle interior.

Therefore, as described above, according to according a heat pump system for a vehicle to an embodiment, by using one chiller 20 where the coolant and the refrigerant are heat-exchanged, the waste heat of the electrical component 3 and the battery module 5 may be recollected depending on the air conditioning mode of the vehicle interior, and the temperature of the battery module 5 may be adjusted. In addition, the present disclosure may increase the flow amount of the refrigerant by applying the gas injection device 30 selectively operating in the selected air conditioning mode of the vehicle interior, thereby improving the cooling and heating performance.

In addition, according to the present disclosure, the performance of the system by using the gas injection device 30 may be maximized while minimizing the required components, and accordingly, streamlining and simplification of the system may be achieved.

In addition, according to an embodiment, by efficiently adjusting the temperature of the battery module 5, the optimal performance of the battery module 5 may be enabled, and the overall travel distance of the vehicle may be increased due to the efficient management of the battery module 5.

In addition, the present disclosure may improve heating efficiency by selectively using the heat from an external heat source or the waste heat of the electrical component 3 in the heating mode of the vehicle interior.

In addition, according to the present disclosure, through streamlining of an entire system, it is possible to reduce manufacturing cost and weight and improve space utilization.

While this present disclosure has been described in connection with what is presently considered to be practical exemplary embodiments, it is to be understood that the present disclosure is not limited to the disclosed embodiments. On the contrary, it is intended to cover various modifications and equivalent arrangements included within the spirit and scope of the appended claims.

### DESCRIPTION OF SYMBOLS

10: compressor
11: refrigerant line
12: HVAC module
13: internal condenser
14: opening/closing door
15: heat-exchanger
16: first expansion valve
17: evaporator
18: accumulator
20: chiller
21: first connection line
23: second expansion valve
25: second connection line
30: gas injection device
31: flash tank
32: third expansion valve
33, 34, 35: first, second, and third lines
36: fourth expansion valve
40: fifth expansion valve
41: third connection line
43: fourth connection line

What is claimed is:

1. A heat pump system for a vehicle, comprising:
a compressor configured to compress a refrigerant;
a heating, ventilation, and air-conditioning (HVAC) module including:
an internal condenser and an evaporator connected to the compressor through a refrigerant line, and
an opening/closing door configured to adjust an air having passed through the evaporator to be selectively introduced into the internal condenser, based on cooling or heating of a vehicle interior;
a heat-exchanger connected to the internal condenser through the refrigerant line, and configured to condense or evaporate the refrigerant by exchanging heat between the supplied refrigerant and the air;
a first expansion valve provided on the refrigerant line between the heat-exchanger and the evaporator;
an accumulator provided on the refrigerant line between the evaporator and the compressor;
a first connection line including: a first end connected to the refrigerant line between the compressor and the evaporator, and a second end connected to the refrigerant line between the heat-exchanger and the evaporator;
a chiller provided on the first connection line, and configured to adjust a temperature of a selectively introduced coolant by exchanging heat between the refrigerant introduced into the first connection line and the coolant;
a second expansion valve provided on the first connection line at an upstream end of the chiller;
a second connection line including: a first end connected to the second expansion valve, and a second end connected to the accumulator;
a gas injection device connected to the refrigerant line between the internal condenser and the heat-exchanger and configured to:
selectively expand the refrigerant supplied from the internal condenser or the heat-exchanger and flow the expanded refrigerant, and
selectively supply a partial refrigerant, among the supplied refrigerant, to the compressor to increase a flow amount of the refrigerant circulating through the refrigerant line; and
a third connection line including: a first end connected to the refrigerant line between the heat-exchanger and the evaporator, and a second end connected to the gas injection device.

2. The heat pump system of claim 1, wherein the gas injection device comprises:
a flash tank configured to separate a gaseous refrigerant and a liquid refrigerant from an interiorly introduced refrigerant and selectively discharge the separated refrigerants;
a third expansion valve provided on the refrigerant line between the internal condenser and the heat-exchanger;
a first line including: a first end connected to the flash tank, and a second end connected to the third expansion valve;
a second line connecting the compressor and the flash tank, and configured to selectively supply the gaseous refrigerant from the flash tank to the compressor;
a third line including: a first end connected to the flash tank, and a second end connected to the refrigerant line between the third expansion valve and the heat-exchanger; and
a fourth expansion valve provided on the third line.

3. The heat pump system of claim 2, wherein the fourth expansion valve is configured to:
selectively expand the refrigerant supplied from the flash tank and supply the expanded refrigerant to the heat-exchanger; or
supply the refrigerant supplied from the flash tank to the chiller or the first expansion valve, in an unexpanded state.

4. The heat pump system of claim 2, wherein the third and fourth expansion valves are selectively operated in a cooling mode, a heating mode, or a heating and dehumidifying mode of the vehicle interior, and configured to selectively expand the refrigerant while controlling a flowing movement of the supplied refrigerant.

5. The heat pump system of claim 2, wherein the flash tank is operated when the expanded refrigerant is supplied, and the flash tank is configured to supply the gaseous refrigerant among the supplied refrigerant to the compressor through the second line, to increase the flow amount of the refrigerant circulating through the refrigerant line.

6. The heat pump system of claim 2, further comprising:
a fifth expansion valve provided on the refrigerant line between the heat-exchanger and the first expansion valve, and connected to a first end of the second connection line; and
a fourth connection line including: a first end connected to the fourth expansion valve, and a second end connected to the refrigerant line between the heat-exchanger and the first expansion valve.

7. The heat pump system of claim 6, wherein:
a first end of the third connection line is connected to the fifth expansion valve; and
a second end of the third connection line is connected to the first line.

8. The heat pump system of claim 6, wherein, when a waste heat of an electrical component is to be recollected in a cooling mode, a heating and dehumidifying mode, or a heating mode of the vehicle interior, the fourth connection line is opened by the fourth expansion valve.

9. The heat pump system of claim 6, wherein, when the gas injection device operates in a cooling mode of the vehicle interior:
a portion of the first line connecting a second end of the third connection line to the flash tank is opened;
a remaining first line connecting the second end of the third connection line to the third expansion valve is closed;
the second line is opened;
a portion of the third line connecting the flash tank to the fourth expansion valve is opened by the fourth expansion valve;
a remaining third line connecting the fourth expansion valve to the refrigerant line is closed by the fourth expansion valve;
the first connection line and the second connection line are closed by the second expansion valve;
the third connection line is opened by the fifth expansion valve;
the fourth connection line is opened by the fourth expansion valve;
the first expansion valve expands the refrigerant introduced through the refrigerant line and supplies the expanded refrigerant to the evaporator;
an operation of the second expansion valve is stopped;
the third expansion valve supplies the refrigerant introduced through the refrigerant line to the heat-exchanger without expansion;
the fourth expansion valve flows the refrigerant supplied from the flash tank through the third line to the fourth connection line without expansion;
the fifth expansion valve expands the refrigerant supplied from the heat-exchanger and flows the expanded refrigerant to the third connection line; and
the flash tank supplies the gaseous refrigerant among the interiorly introduced refrigerant to the compressor through the opened second line.

10. The heat pump system of claim 6, wherein, when the gas injection device operates and cooling of a battery module is required in a cooling mode of the vehicle interior:
a portion of the first line connecting a second end of the third connection line to the flash tank is opened;
a remaining first line connecting the second end of the third connection line to the third expansion valve is closed;
the second line is opened;
a portion of the third line connecting the flash tank to the fourth expansion valve is opened by the fourth expansion valve;
a remaining third line connecting the fourth expansion valve to the refrigerant line is closed by the fourth expansion valve;
a portion of the refrigerant line connecting the fifth expansion valve to a second end of the fourth connection line is closed by the fifth expansion valve;
the first connection line is opened by the second expansion valve;
the second connection line is closed by the second expansion valve;
the third connection line is opened by the fifth expansion valve;
the fourth connection line is opened by the fourth expansion valve;
the first expansion valve expands the refrigerant introduced through the fourth connection line and a portion of the refrigerant line from the flash tank, and supplies the expanded refrigerant to the evaporator;
the second expansion valve expands the refrigerant introduced through the fourth connection line, a portion of the refrigerant line, and the first connection line from the flash tank, and supplies the expanded refrigerant to the chiller;
the third expansion valve supplies the refrigerant introduced through the refrigerant line to the heat-exchanger without expansion;
the fourth expansion valve flows the refrigerant supplied from the flash tank through the third line to the fourth connection line without expansion;
the fifth expansion valve expands the refrigerant supplied from the heat-exchanger and flows the expanded refrigerant to the third connection line; and
the flash tank supplies the gaseous refrigerant among the interiorly introduced refrigerant to the compressor through the opened second line.

11. The heat pump system of claim 6, wherein, when the gas injection device operates and a waste heat of an electrical component is to be recollected in a heating mode of the vehicle interior:
a portion of the refrigerant line connecting the compressor and the internal condenser and a portion of the refrigerant line connecting the internal condenser and the third expansion valve are opened by the third expansion valve;
a portion of the refrigerant line connecting the first connection line and the compressor is opened;
a portion of the refrigerant line connecting the heat-exchanger and the third expansion valve is closed by the third expansion valve;
a portion of the refrigerant line connecting the heat-exchanger and a second end of the fourth connection line is closed by the fifth expansion valve;
a portion of the refrigerant line connecting a second end of the first connection line to the evaporator is closed by the first expansion valve;
a portion of the refrigerant line connecting the evaporator and a first end of the first connection line is closed;
the first line is opened by the third expansion valve;
the second line is opened;
a portion of the third line connecting the flash tank and the fourth expansion valve is opened by the fourth expansion valve;
a remaining third line connecting the fourth expansion valve and the refrigerant line is closed by the fourth expansion valve;
the first connection line is opened by the second expansion valve;
the second connection line is closed by the second expansion valve;
the third connection line is closed by the fifth expansion valve;
the fourth connection line is opened by the fourth expansion valve;
operations of the first expansion valve and the fifth expansion valve are stopped;
the second expansion valve expands the refrigerant introduced through the fourth connection line and the first connection line from the flash tank and supplies the expanded refrigerant to the chiller;
the third expansion valve expands the refrigerant supplied from the internal condenser and supplies the expanded refrigerant to the flash tank;
the fourth expansion valve flows the refrigerant supplied from the flash tank through the third line to the fourth connection line without expansion; and
the flash tank supplies the gaseous refrigerant among the interiorly introduced refrigerant to the compressor through the opened second line.

12. The heat pump system of claim 6, wherein, when the gas injection device operates and an ambient air heat source is to be recollected in a heating mode of the vehicle interior:
a portion of the refrigerant line connecting the compressor and the internal condenser and a portion of the refrigerant line connecting the internal condenser and the third expansion valve are opened by the third expansion valve;
a portion of the refrigerant line connecting the evaporator and the accumulator is closed;
a portion of the refrigerant line connecting the third expansion valve to a second end of the third line is closed by the third expansion valve;
a portion of the refrigerant line connecting the heat-exchanger to the second end of the third line is opened by the fourth expansion valve;
a portion of the refrigerant line connecting the heat-exchanger to a second end of the first connection line is opened by the fifth expansion valve;
a portion of the refrigerant line connected from a first end of the first connection line to the evaporator and, a portion of the refrigerant line connecting the evaporator to the accumulator are closed by the first expansion valve;
the first line is opened by the third expansion valve;
the second line is opened;
the third line is opened by the fourth expansion valve;
a portion of the first connection line connecting the second end of the first connection line to the second expansion valve is opened by the second expansion valve;
a portion of the first connection line connecting the second expansion valve to the refrigerant line by passing through the chiller is closed by the second expansion valve;
the second connection line is opened by the second expansion valve;
the third connection line is closed by the fifth expansion valve;
the fourth connection line is closed by the fourth expansion valve;
an operation of the first expansion valve is stopped;
the second expansion valve flows the refrigerant introduced through the refrigerant line and the first connection line from the heat-exchanger to the second connection line without expansion;
the third expansion valve expands the refrigerant supplied from the internal condenser and supplies the expanded refrigerant to the flash tank;
the fourth expansion valve expands the refrigerant supplied from the flash tank through the third line, and supplies the expanded refrigerant to the heat-exchanger through the refrigerant line;
the fifth expansion valve flows the refrigerant introduced from the heat-exchanger through the refrigerant line to the refrigerant line and the first connection line without expansion; and
the flash tank supplies the gaseous refrigerant among the interiorly introduced refrigerant to the compressor through the opened second line.

13. The heat pump system of claim 6, wherein, when the gas injection device operates in a heating and dehumidifying mode of the vehicle interior:
a portion of the refrigerant line connecting the compressor and the internal condenser and a portion of the refrigerant line connecting the internal condenser and the third expansion valve are opened by the third expansion valve;
a portion of the refrigerant line connecting the evaporator and the compressor is opened;
a portion of the refrigerant line connecting a second end of the fourth connection line to the evaporator is opened by the first expansion valve;
a portion of the refrigerant line connecting the heat-exchanger and the third expansion valve is closed by the third expansion valve;
a portion of the refrigerant line connecting the heat-exchanger and the second end of the fourth connection line is closed by the fifth expansion valve;
a portion of the refrigerant line connecting the third expansion valve to a second end of the third line is closed by the third expansion valve;
the first line is opened by the third expansion valve;
the second line is opened;
a portion of the third line connecting the flash tank and the fourth expansion valve is opened by the fourth expansion valve;
a remaining third line connecting the fourth expansion valve and the refrigerant line is closed by the fourth expansion valve;
the first connection line is opened by the second expansion valve;
the second connection line is closed by the second expansion valve;
the third connection line is closed by the fifth expansion valve;
the fourth connection line is opened by the fourth expansion valve;
the first expansion valve expands the refrigerant introduced through the fourth connection line and a portion of the refrigerant line from the flash tank, and supplies the expanded refrigerant to the evaporator;
the second expansion valve expands the refrigerant introduced through the first connection line, and supplies the expanded refrigerant to the chiller;
the third expansion valve expands the refrigerant supplied from the internal condenser and supplies the expanded refrigerant to the flash tank;
the fourth expansion valve flows the refrigerant supplied from the flash tank through the third line to the fourth connection line without expansion; and
the flash tank supplies the gaseous refrigerant among the interiorly introduced refrigerant to the compressor through the opened second line.

14. The heat pump system of claim 6, wherein the second expansion valve, the third expansion valve, the fourth expansion valve, and the fifth expansion valve are 3-way electronic expansion valves configured to selectively expand the refrigerant while controlling a flowing movement of the refrigerant.

15. The heat pump system of claim 6, further comprising a sub-heat-exchanger provided on the refrigerant line between the first expansion valve and the fifth expansion valve, the sub-heat-exchanger configured to exchange heat between the refrigerant supplied from the heat-exchanger through the refrigerant line or the refrigerant supplied from the fourth connection line through the refrigerant line and the refrigerant supplied from either the evaporator or the chiller.

16. The heat pump system of claim 1, further comprising a cooling apparatus comprising an electrical component and a battery module through which the coolant circulates,
wherein the chiller is connected to the electrical component through a first coolant line through which the coolant circulates, and connected to the battery module through a second coolant line through which the coolant circulates.

17. The heat pump system of claim 16, wherein, when a waste heat of the electrical component is to be recollected in a heating mode of the vehicle interior, the first coolant line is opened to connect the chiller and the electrical component.

18. The heat pump system of claim 16, wherein, when the battery module is to be cooled in a cooling mode of the vehicle, or when a waste heat of the battery module is to be recollected in a heating mode of the vehicle interior, the second coolant line is opened to connect the chiller and the battery module.
